(19) United States
(12) Patent Application Publication
(10) Pub. No.: US 2018/0292194 A1
(43) Pub. Date: Oct. 11, 2018

(54) KIT AND METHOD FOR MEASURING A PIPE COUPLING GROOVE

(71) Applicant: Michael MERTO, Smithtown, NY (US)

(72) Inventor: Michael MERTO, Smithtown, NY (US)

(21) Appl. No.: 15/480,749

(22) Filed: Apr. 6, 2017

(51) Int. Cl. G01B 3/38; F16L 21/06

(52) U.S. Cl. CPC G01B 3/38; F16L 21/06

(57) ABSTRACT

A pipe groove gauge kit for measuring the width, depth and location of a coupling groove adjacent an end of a pipe includes a plurality of pipe groove gauges. Each pipe groove gauge includes a rigid, planar member extending in a longitudinal direction. The planar member has a leg disposed at a first end and a tab disposed between the first and second ends. The leg has an inner edge adapted to be held against an end of an associated length of pipe and the tab is adapted to be inserted into a coupling groove of the associated length of pipe. The tab height corresponds to a specified depth of a coupling groove for a particular pipe configuration and the tab width corresponds to a specified width of the coupling groove for the particular pipe configuration.

### BACKGROUND OF THE INVENTION

### 1. Field of the Invention

The present invention relates to a pipe groove gauge kit and method for measuring the width, depth and location of a coupling groove adjacent an end of a length of pipe.

### 2. The Prior Art

It is known to join various types of pipes using mechanical coupling devices. In order to facilitate the coupling of the ends of two adjacent lengths of pipe using certain mechanical coupling devices, a coupling groove is provided proximate an end of each length of pipe. The mechanical coupling device is seated in the coupling groove and may provide a rigid or flexible coupling depending on the particular application.

The pipe may be formed, for example, from steel, copper, plastic, stainless steel or ductile iron pipe. The coupling groove may be formed by various manufacturing processes, for example by cutting or rolling.

In order to assure a reliable coupled pipe joint, the coupling groove on each of the two lengths of grooved pipe to be joined must conform to certain specifications. For example, the distance of the coupling groove from the end face of the pipe, the width of the coupling groove and the depth of the coupling groove must all have certain dimensions and/or be within certain tolerances for the particular pipe material, pipe diameter (or range of diameters) and groove forming method (for example cut grooves or cold rolled grooves) of the pipes to be joined.

Additionally, there should be no flaring of the pipe which can occur when a coupling groove is not properly machined in the pipe, causing the surface of the pipe to deform and flare out in an area adjacent the groove such that the flared portion of pipe is not parallel with the longitudinal axis of the remainder of the length of pipe.

Accordingly, there exists a need for a pipe groove gauge and a method for evaluating the width, depth and location of a coupling groove adjacent an end of a length of pipe to be joined with a mechanical coupling device. A need further exists for a pipe groove gauge which is durable, compact in size and can be easily used in the field to reliably indicate whether a particular coupling groove and grooved pipe conform to certain specifications in order to provide an acceptable coupled pipe joint. Moreover, a need exists for a kit including a number of pipe groove gauges which correspond to various pipe configurations such a pipe material, diameter and coupling groove type.

These and other advantages are achieved by a pipe groove gauge kit and a method for measuring the width, depth and location of a coupling groove according to aspects of the invention.

### SUMMARY OF THE INVENTION

A pipe groove gauge kit for measuring the width, depth and location of a coupling groove adjacent an end of a pipe to be joined with a mechanical coupling device is provided. The kit includes a plurality of pipe groove gauges. Each pipe groove gauge includes a rigid, planar member extending in a longitudinal direction.

The rigid planar member has a first end, a second end opposite the first end, a first side and a second side opposite the first side.

The rigid planar member further has a first leg disposed at the first end of the rigid planar member and projecting perpendicularly to the longitudinal direction from the first side. The first leg has a first leg inner edge adapted to be held against an end of an associated length of pipe.

The rigid planar member further has a first tab disposed between the first end and the second end of the rigid planar member and projecting perpendicularly to the longitudinal direction from the first side. The first tab is adapted to be inserted into a coupling groove of the associated length of pipe and has a first tab height, a first tab width and a first tab inner edge spaced apart from the first leg inner edge over a first inner edge distance.

At least one of the first tab height, the first tab width and the first inner edge distance for each pipe groove gauge of the kit is distinct from that of each other pipe groove gauge of the kit. For each pipe groove gauge of the kit, the first tab height corresponds to a specified depth of a coupling groove for a particular pipe configuration, the first tab width corresponds to a specified width of the coupling groove for the particular pipe configuration and the first inner edge distance corresponds to a specified distance of an inner edge of the coupling groove from the end of the pipe for the particular pipe configuration.

In another aspect, each pipe groove gauge of the plurality of pipe grove gauges is marked with indicia indicating the particular pipe configuration associated therewith. The indicia may correspond to a pipe material, a pipe diameter, a range of pipe diameters and/or a groove forming method for the pipes to be joined.

In another aspect, at least one pipe groove gauge of the plurality of pipe groove gauges further includes a second leg disposed at the second end of the rigid planar member and projecting perpendicularly to the longitudinal direction from the second side. The second leg has a second leg inner edge adapted to be held against an end of an associated length of pipe. The pipe groove gauge further has a second tab disposed between the first end and the second end of the rigid planar member and projecting perpendicularly to the longitudinal direction from the second side. The second tab is adapted to be inserted into a coupling groove of the associated length of pipe and has a second tab height, a second tab width and a second tab inner edge spaced apart from the second leg inner edge over a second inner edge distance.

At least one of the second tab height, second tab width and second inner edge distance of the pipe groove gauge is distinct from the first tab height, first tab width and first inner edge distance of the pipe groove gauge. The second tab height corresponds to a specified depth of a coupling groove for a particular pipe configuration, the second tab width corresponds to a specified width of the coupling groove for the particular pipe configuration and said second inner edge distance corresponds to a specified distance of an inner edge of the coupling groove from the end of the pipe for the particular pipe configuration.

In another aspect, the rigid planar member includes one or more openings adjacent the first end and/or second end.

A method for measuring the width, depth and location of a coupling groove adjacent an end of a pipe is provided. The method includes the step of providing a pipe groove gauge comprising a rigid, planar member extending in a longitudinal direction.

The rigid planar member includes a first end, a second end opposite the first end, a first side and a second side opposite the first side.

The rigid planar member further includes a leg disposed at the first end of the rigid planar member and projecting perpendicularly to the longitudinal direction from the first side. The leg has a leg inner edge adapted to be held against an end of an associated length of pipe.

The rigid planar member further includes a tab disposed between the first end and the second end of the rigid planar member and projecting perpendicularly to the longitudinal direction from the first side. The tab is adapted to be inserted into a coupling groove of the associated length of pipe and has a tab height, a tab width and a tab inner edge spaced apart from the leg inner edge over an inner edge distance.

The rigid planar member also has indicia indicating a particular pipe configuration associated with the pipe groove gauge. The tab height corresponds to a specified depth of a coupling groove for the particular pipe configuration, the tab width corresponds to a specified width of the coupling groove for the particular pipe configuration and the inner edge distance corresponds to a specified distance of an inner edge of the coupling groove from the end of the pipe for the particular pipe configuration.

The method further includes the step of placing the pipe groove gauge on a length of pipe having the particular pipe configuration corresponding to the indicia on the pipe groove gauge such that the inner edge of the leg is held against an end surface of the length of pipe and the tab is inserted into a coupling groove of the length of pipe.

The method further includes the step of determining whether the coupling groove conforms to a specified width, depth and location for the particular pipe configuration by visually confirming that the tab fits snugly in the coupling groove and that the first side of the rigid planar member on either side of the tab lie flush against a surface of the length of pipe.

An advantage of a pipe groove gauge kit and method for measuring the width, depth and location of a coupling groove adjacent an end of a length of pipe according to aspects of the invention is that a durable, compact gauge is provided which can easily be used in the field to reliably indicate whether a particular coupling groove and grooved pipe conform to certain requirements, including the coupling groove width, depth and location and the absence of flare, in order to provide an acceptable coupled pipe joint. A further advantage of a pipe groove gauge, kit and method according to aspects of the invention is that a kit is provided which includes a number of pipe groove gauges for use with various pipe configurations including various pipe materials, diameters and coupling groove types. Another advantage of a pipe groove gauge kit and method according to aspects of the invention is that a two-sided pipe groove gauge having measuring legs and tabs at both sides may be provided, thereby allowing for measurement of different pipe configurations with a single unitary gauge. Another advantage of a pipe groove gauge kit and method according to aspects of the invention is that indicia is provided on the pipe groove gauge such that a user can quickly and easily identify and select an appropriate gauge to be used with a particular pipe and groove configuration.

### BRIEF DESCRIPTION OF THE DRAWINGS

Other benefits and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a coupling device joining two lengths of grooved pipe;

FIG. 2 shows a pipe groove gauge being used to measure a pipe with a coupling groove according to an embodiment of the invention;

FIG. 3 shows a pipe groove gauge according to an embodiment of the invention;

FIG. 4 shows a pipe groove gauge according to another embodiment of the invention; and

FIG. 5 shows a pipe groove gauge kit according to an embodiment of the invention.

### DETAILED DESCRIPTION OF THE DRAWINGS

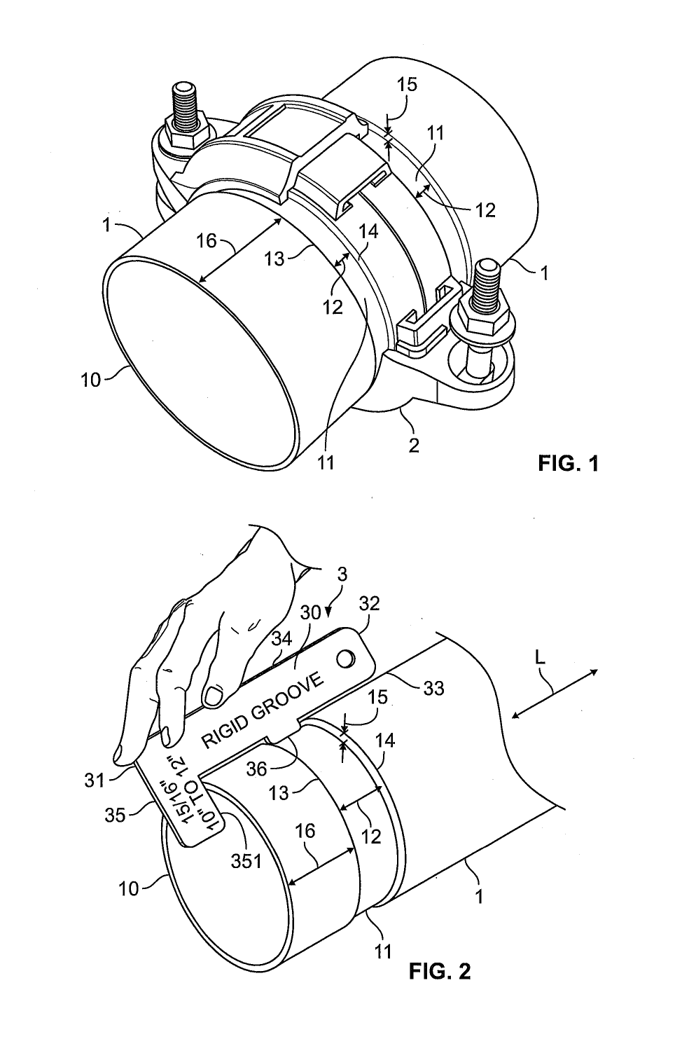

Referring now in detail to the drawings and, in particular, FIG. 1 shows a mechanical coupling device 2 or clamp for joining two lengths of grooved pipe 1. As shown, the coupling device 2 is seated in each of the coupling grooves 11 which are provided proximate the respective ends 10 of the lengths of pipe 1 to be coupled together.

The pipe 1 may be made from various materials, such as for example, steel, copper, plastic, stainless steel or ductile iron pipe. The coupling groove 11 may be formed by various manufacturing processes, such as for example, by cutting or rolling. In order to provide an acceptable reliable coupling, the coupling groove 11 and pipe 1 must meet certain standards. In particular, the distance 16 of the coupling groove inner edge 13 from the end 10 of the pipe 1, the width 12 of the coupling groove 11 and the depth 15 of the coupling groove 11 must have certain dimensions as may be specified by for example, the pipe or coupling manufacturer.

These dimensions will depend on the particular pipe configuration of the grooved pipes to be joined. Pipe configuration as used herein may refer to the particular pipe material, pipe diameter (or range of diameters) and/or coupling groove forming method (for example cut groove or rolled groove).

Additionally, in order to provide an acceptable and reliable coupling, there should be no flaring of the pipe 1 which can occur when the coupling groove 11 is not properly machined in the pipe, causing the surface of the pipe 1 to be deformed and “flare” out such that it is not parallel with the longitudinal axis of the pipe.

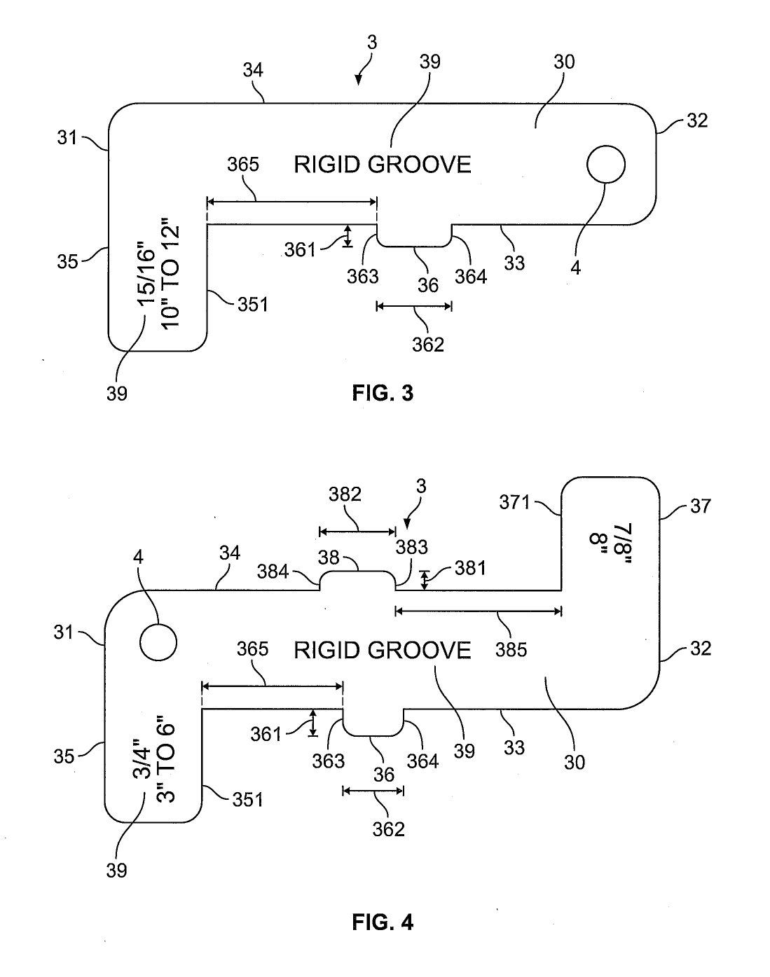

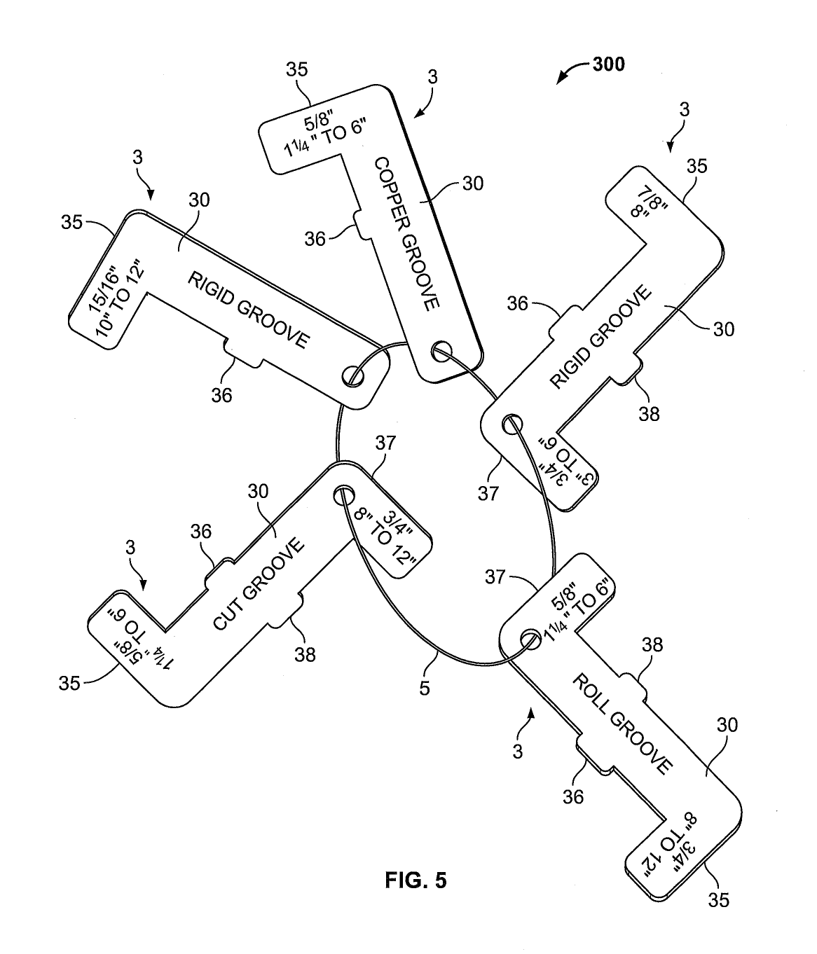

FIG. 5 shows a pipe groove gauge kit 300 for measuring the width, depth and location of a coupling groove 11 adjacent an end of a pipe according to an embodiment of the invention. The kit 300 may include a plurality of pipe groove gauges 3 as shown in FIGS. 2-5.

Each pipe groove gauge 3 of the kit 300 includes a rigid, planar member 30 extending in a longitudinal direction L. The rigid planar member 30 may be formed from any suitable material, for example stainless steel.

The rigid planar member 30 includes a first end 31, a second end 32 opposite first end 31, a first side 33 and a second side 34 opposite first side 33.

A first leg 35 is disposed at the first end 31 of the rigid planar member 30 and projects perpendicularly to the longitudinal direction L from the first side 33. The first leg 35 has a first leg inner edge 351 adapted to be held against an end 10 of an associated length of pipe 1 as shown for example in FIG. 2.

The rigid planar member 30 further includes a first tab or projection 36 disposed between the first end 31 and second end 32 of the rigid planar member 30. The tab 36 projects perpendicularly to the longitudinal direction L from the first side 33. The first tab 36 is adapted to be inserted into a coupling groove 11 of the associated length of pipe 1 as shown for example in FIG. 2, The first tab 36 has a first tab height 361, a first tab width 362, a first tab outer edge 364 and a first tab inner edge 363 spaced apart from the first leg inner edge 351 over a first inner edge distance 365.

First tab height 361 is the distance from the first side 33 of planar member 30 to a top of the first tab 36. First tab width 362 is the distance from first tab outer edge 364 to first tab inner edge 363.

At least one of the first tab height 361, first tab width 362 and first inner edge distance 365 for each pipe groove gauge 3 of the plurality of pipe groove gauges in kit 300 is distinct from that of each other pipe groove gauge of the plurality of pipe groove gauges in the kit 30.

For each pipe groove gauge 3 of the plurality of pipe groove gauges in the kit, the first tab height 361 corresponds to a specified depth 15 of a coupling groove 11 for a particular pipe configuration, the first tab width 362 corresponds to a specified width 12 of the coupling groove 11 for the particular pipe configuration and the first inner edge distance 365 corresponds to a specified distance 16 of an inner edge 13 of the coupling groove 11 from the end 10 of the pipe 1 (the land) for the particular pipe configuration.

As shown in FIGS. 2-5, the pipe groove gauge 3 may be marked with indicia 39 indicating the particular pipe configuration associated therewith. The indicia 39 may be provided by printing, stamping, embossing or any other suitable method. Indicia 39 may indicate, for example, the pipe material, pipe diameter, range of pipe diameters and/or groove forming method for the particular grooved pipe associated with the pipe groove gauge 3 bearing the indicia 39.

As shown in FIGS. 4 and 5, according to a further embodiment of the invention, a two-sided pipe groove gauge is provided, such that a single pipe groove gauge may be used for two different grooved pipe configurations. In this embodiment, the rigid planar member 30 has a second leg 37 disposed at the second end 32 of the rigid planar member 30. Second leg 37 projects perpendicularly to the longitudinal direction L from second side 34 of planar member 30. The second leg 37 has a second leg inner edge 371 adapted to be held against an end 10 of an associated length of pipe 1.

In this embodiment, rigid planar member 30 also has a second tab 38 disposed between first end 31 and second end 32 of rigid planar member 30 and projecting perpendicularly to longitudinal direction L from the second side 34. The second tab 38 is adapted to be inserted into a coupling groove 11 of the associated length of pipe,

Second tab 38 has a second tab height 381, a second tab width 382, a second tab outer edge 384 and a second tab inner edge 383 spaced apart from the second leg inner edge 371 over a second inner edge distance 385.

Second tab height 381 is the distance from the second side 34 of planar member 30 to a top of the second tab 38. Second tab width 382 is the distance from second tab outer edge 384 to second tab inner edge 383.

In the double-sided gauge embodiment, at least one of the second tab height 381, the second tab width 382 and the second inner edge distance 385 of the pipe groove gauge 3 is distinct from the first tab height 361, first tab width 362 and first inner edge distance 365 of the pipe groove gauge 3.

The second tab height 381 corresponds to a specified depth 15 of a coupling groove 11 for a particular pipe configuration, the second tab width 382 corresponds to a specified width 12 of the coupling groove 11 for the particular pipe configuration and the second inner edge distance 385 corresponds to a specified distance 16 of an inner edge 13 of the coupling groove from the end 10 of the pipe 1 (the land) for the particular pipe configuration.

The rigid planar member 30 may further have an opening 4 adjacent its first end 31 and/or second end 32. The opening 4 can facilitate the fastening of two or more pipe groove gauges 3 with a ring 5, as shown in FIG. 5, in the manner of a key ring, to provide convenient storage and access. Opening 4 may also be used to hang one or more pipe groove gauges 3 according to embodiments of the invention on a hook.

A method for measuring the width, depth and location of a coupling groove 11 adjacent an end 10 of a pipe 1 according to an embodiment of the invention includes the step of providing a pipe groove gauge 3 having at least one leg and at least one tab as set forth above. The pipe groove gauge 3 may include indicia 39 indicating a particular pipe configuration associated with the pipe groove gauge 3.

As shown in FIG. 2, the pipe grove gauge 3 is placed on a length of pipe 1 having the particular pipe configuration corresponding to the indicia 39 on the pipe groove gauge such that the inner edge 351 of the leg 35 is held against an end surface of the length of pipe and the tab 36 is inserted into a coupling groove 11 of the length of pipe.

The user than determines whether the coupling groove 11 conforms to a specified width, depth and location for the particular pipe configuration by visually confirming that the tab 36 fits snugly in the coupling groove 11 and that the first side 33 of the rigid planar member 30 on either side of the tab 36 lies flush against a surface of the length of pipe.

Although several embodiments of the present invention have been shown and described, it is obvious that many changes and modifications may be made thereunto without departing from the spirit and scope of the invention.

### REFERENCE NUMERALS

pipe groove gauge kit 300
pipe 1
pipe end 10
coupling device 2
coupling groove 11
width of coupling groove 12
inner edge of coupling groove 13
outer edge of coupling groove 14
depth of coupling groove 15
distance of coupling groove inner edge from pipe end 16
pipe groove gauge 3
planar member 30
longitudinal direction L
first end of planar member 31
second end of planar member 32
first side of planar member 33
second side of planar member 34
first leg 35
first leg inner edge 351
first tab 36
first tab height 361
first tab width 362
first tab inner edge 363
first tab outer edge 364
first inner edge distance 365
second leg 37
second leg inner edge 371
second tab 38
second tab height 381
second tab width 382
second tab inner edge 383
second tab outer edge 384
second inner edge distance 385
indicia 39
opening 4
ring 5

What is claimed is:

1. A pipe groove gauge kit for measuring the width, depth and location of a coupling groove adjacent an end of a pipe, the kit comprising:
a plurality of pipe groove gauges, each pipe groove gauge of said plurality of pipe groove gauges comprising a rigid, planar member extending in a longitudinal direction, said rigid planar member comprising:
(a) a first end, a second end opposite said first end, a first side and a second side opposite said first side;
(b) a first leg disposed at said first end of said rigid planar member and projecting perpendicularly to said longitudinal direction from said first side, said first leg having a first leg inner edge adapted to be held against an end of an associated length of pipe; and
(c) a first tab disposed between said first end and said second end of said rigid planar member and projecting perpendicularly to said longitudinal direction from said first side, said first tab being adapted to be inserted into a coupling groove of the associated length of pipe, said first tab having a first tab height, a first tab width and a first tab inner edge spaced apart from said first leg inner edge over a first inner edge distance,
wherein at least one of said first tab height, said first tab width and said first inner edge distance for each pipe groove gauge of said plurality of pipe groove gauges is distinct from that of each other pipe groove gauge of said plurality of pipe groove gauges in the kit; and
wherein for each pipe groove gauge of said plurality of pipe groove gauges, said first tab height corresponds to a specified depth of a coupling groove for a particular pipe configuration, said first tab width corresponds to a specified width of the coupling groove for the particular pipe configuration and said first inner edge distance corresponds to a specified distance of an inner edge of the coupling groove from the end of the pipe for the particular pipe configuration.

2. The pipe groove gauge kit according to claim 1, wherein each pipe groove gauge of said plurality of pipe grove gauges is marked with indicia indicating the particular pipe configuration associated therewith.

3. The pipe groove gauge kit according to claim 2, wherein said indicia corresponds to at least one property selected from the group consisting of a pipe material, a pipe diameter, a range of pipe diameters and a groove forming method.

4. The pipe groove gauge kit according to claim 1, wherein said rigid planar member of at least one pipe groove gauge of said plurality of pipe groove gauges further comprises:
(a) a second leg disposed at said second end of said rigid planar member and projecting perpendicularly to said longitudinal direction from said second side, said second leg having a second leg inner edge adapted to be held against an end of an associated length of pipe; and
(b) a second tab disposed between said first end and said second end of said rigid planar member and projecting perpendicularly to said longitudinal direction from said second side, said second tab being adapted to be inserted into a coupling groove of the associated length of pipe, said second tab having a second tab height, a second tab width and a second tab inner edge spaced apart from said second leg inner edge over a second inner edge distance,
wherein at least one of said second tab height, said second tab width and said second inner edge distance of said pipe groove gauge is distinct from said first tab height, said first tab width and said first inner edge distance of said pipe groove gauge; and
wherein said second tab height corresponds to a specified depth of a coupling groove for a particular pipe configuration, said second tab width corresponds to a specified width of the coupling groove for the particular pipe configuration and said second inner edge distance corresponds to a specified distance of an inner edge of the coupling groove from the end of the pipe for the particular pipe configuration.

5. The pipe groove gauge kit according to claim 1, wherein said rigid planar member further comprises an opening adjacent at least one of said first end and said second end.

6. A method for measuring the width, depth and location of a coupling groove adjacent an end of a pipe, the method comprising the steps of:
(a) providing a pipe groove gauge comprising a rigid, planar member extending in a longitudinal direction, the rigid planar member comprising:
i) a first end, a second end opposite the first end, a first side and a second side opposite the first side;
(ii) a leg disposed at the first end of the rigid planar member and projecting perpendicularly to the longitudinal direction from the first side, the leg having a leg inner edge adapted to be held against an end of an associated length of pipe;
(iii) a tab disposed between the first end and the second end of the rigid planar member and projecting perpendicularly to the longitudinal direction from the first side, the tab being adapted to be inserted into a coupling groove of the associated length of pipe, the tab having a tab height, a tab width and a tab inner edge spaced apart from the leg inner edge over an inner edge distance; and
(iv) indicia indicating a particular pipe configuration associated with the pipe groove gauge, wherein the tab height corresponds to a specified depth of a coupling groove for the particular pipe configuration, the tab width corresponds to a specified width of the coupling groove for the particular pipe configuration and the inner edge distance corresponds to a specified distance of an inner edge of the coupling groove from the end of the pipe for the particular pipe configuration;
(b) placing the pipe groove gauge on a length of pipe having the particular pipe configuration corresponding to the indicia on the pipe groove gauge such that the inner edge of the leg is held against an end surface of the length of pipe and the tab is inserted into a coupling groove of the length of pipe; and
(c) determining whether the coupling groove conforms to a specified width, depth and location for the particular pipe configuration by visually confirming that the tab fits snugly in the coupling groove and that the first side of the rigid planar member on either side of the tab lies flush against a surface of the length of pipe.

7. The method according to claim 6, wherein the indicia corresponds to at least one property selected from the group consisting of a pipe material, a pipe diameter, a range of pipe diameters and a groove forming method.
